(19) United States
(12) Patent Application Publication
(10) Pub. No.: US 2013/0321467 A1
(43) Pub. Date: Dec. 5, 2013

(54) USING SNAPSHOTS TO REPRESENT SLOW APPLICATIONS

(71) Applicants: Henry Tappen, Redmond, WA (US); Alex Snitkovskiy, Renton, WA (US); Gabriel DeBacker, Carnation, WA (US); Charing Wong, Seattle, WA (US)

(72) Inventors: Henry Tappen, Redmond, WA (US); Alex Snitkovskiy, Renton, WA (US); Gabriel DeBacker, Carnation, WA (US); Charing Wong, Seattle, WA (US)

(73) Assignee: MICROSOFT CORPORATION, Redmond, WA (US)

(21) Appl. No.: 13/485,960

(22) Filed: Jun. 1, 2012

(51) Int. Cl. G09G 5/00

(52) U.S. Cl. 345/649; 345/619

(57) ABSTRACT

In response to certain inputs to an application, the operating system generates a snapshot of the graphical interface of an application. Such inputs include, but are not limited, actions that initiate an update of the graphical interface in the display area for the application, such as repositioning, resizing and/or rotating the display area, bringing the display area onto the display, and removing the display area from the display. Other actions that may initiate creation and use of a snapshot include suspending an application, bringing an application into the foreground, and swapping data for an application into and out of main memory. The operating system updates the display area for the application using the snapshot until the application has completed updating its graphical interface for the modified display area. While the application is updating its graphical interface, the operating system can manage other inputs to the application.

### BACKGROUND

Generally speaking, an application running on a general purpose computer typically has an associated display area, such as a window, on a display through which the application presents a graphical interface through which a user interacts with the application. An application can respond to user input and update its display area slowly, whether due to time taken to access data, transitioning from being a background task to a foreground task, swapping data into memory from disk, availability of system resources, errors, or other reasons. Users can report having unpleasant experiences with applications that are slow to respond to user input.

Some operating systems detect whether an application is nonresponsive to messages from the operating system as a way of determining whether the application is nonresponsive to a user. If an application is detected as nonresponsive, the user can be notified that the application is not responding to the operating system and the user can instruct the operating system to terminate the application. However, in some cases, the operating system does not detect that the application is nonresponsive and thus cannot notify the user. In some cases, the application is responsive, but just slow. In such cases, the user may still have an unpleasant experience with the nonresponsive application, or may presume that the operating system is performing poorly, not just the application.

### SUMMARY

This Summary introduces concepts in a simplified form that are further described below in the Detailed Description. This Summary is neither intended to identify essential features of the claimed subject matter, nor to limit the scope of the claimed subject matter.

In response to certain inputs to an application, the operating system generates a snapshot of the graphical interface of an application. Such inputs include, but are not limited, actions that initiate an update of the graphical interface in the display area for the application, such as repositioning, resizing and/or rotating the display area, bringing the display area onto the display, and removing the display area from the display. Other actions that may initiate creation and use of a snapshot include, but are not limited to, suspending an application, bringing an application into the foreground, and swapping data for an application into and out of main memory to local disk, other storage or over a network.

The operating system updates the display area for the application using the snapshot until the application has completed updating its graphical interface for the modified display area. While the application is updating its graphical interface, the operating system can manage other inputs to, and the graphical representation of, the application.

When the application has completed the operation that triggered the use of a snapshot, the operating system hands control of the display area back to the application which in turn displays its updated graphical interface. A smooth transition between the snapshot and the actual graphical interface can be implemented.

By using a snapshot in this way, the user notices that the system is responsive and, if an application interaction is slow, the user notices the application, not the underlying system, is performing poorly. Further, the operating system prevents multiple inputs from being presented to an application until the application is in a stable state in which those inputs can be reliably processed. In addition, using a snapshot in this way allows the system to reliably position the display area for an application where that display area is supposed to be, especially in environments that have no overlapping windows. Finally, this operating system manages the use of the snapshot, and provides this capability without programming the application to do so.

In the following description, reference is made to the accompanying drawings which form a part hereof, and in which are shown, by way of illustration, specific example implementations. Other implementations may be made within, and the example implementations are not intended to limit, the scope of the claimed subject matter.

### DESCRIPTION OF THE DRAWINGS

FIG. 1 is a data flow diagram of an example system that provides snapshots for slow applications.

FIG. 2 is a flow chart describing an example operation of the system in FIG. 1.

FIG. 3 is a flow chart describing an example operation of the system in FIG. 1.

FIG. 4 is a flow chart describing an example operation of the system in FIG. 1.

FIG. 5 is a block diagram of example computing functionality in which such a system can be implemented.

### DETAILED DESCRIPTION

The following section provides an example operating environment in which the use of snapshots for slow applications can be implemented.

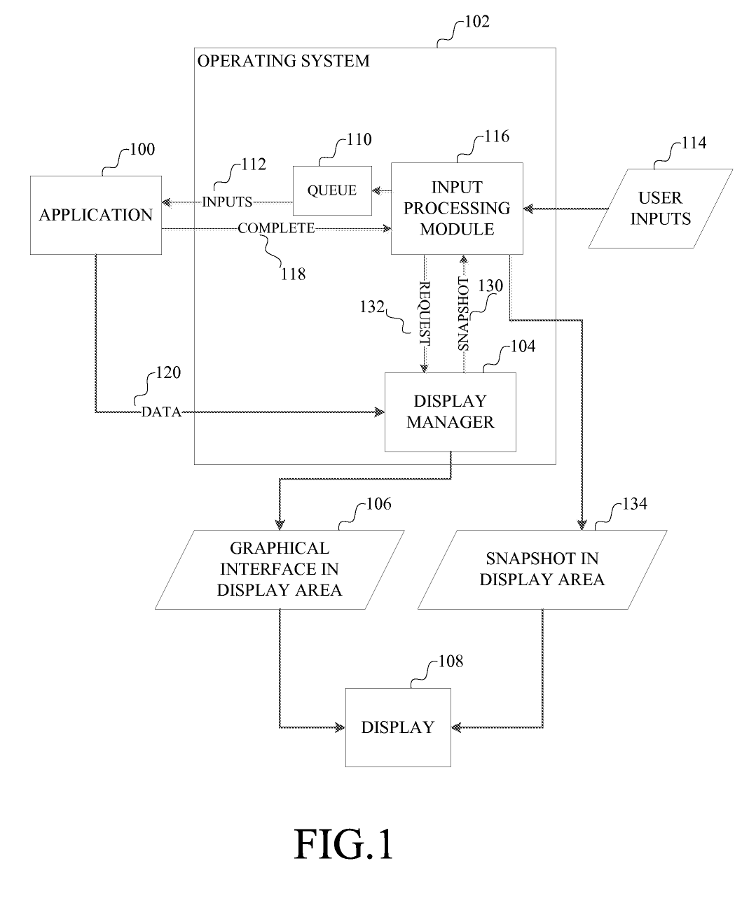

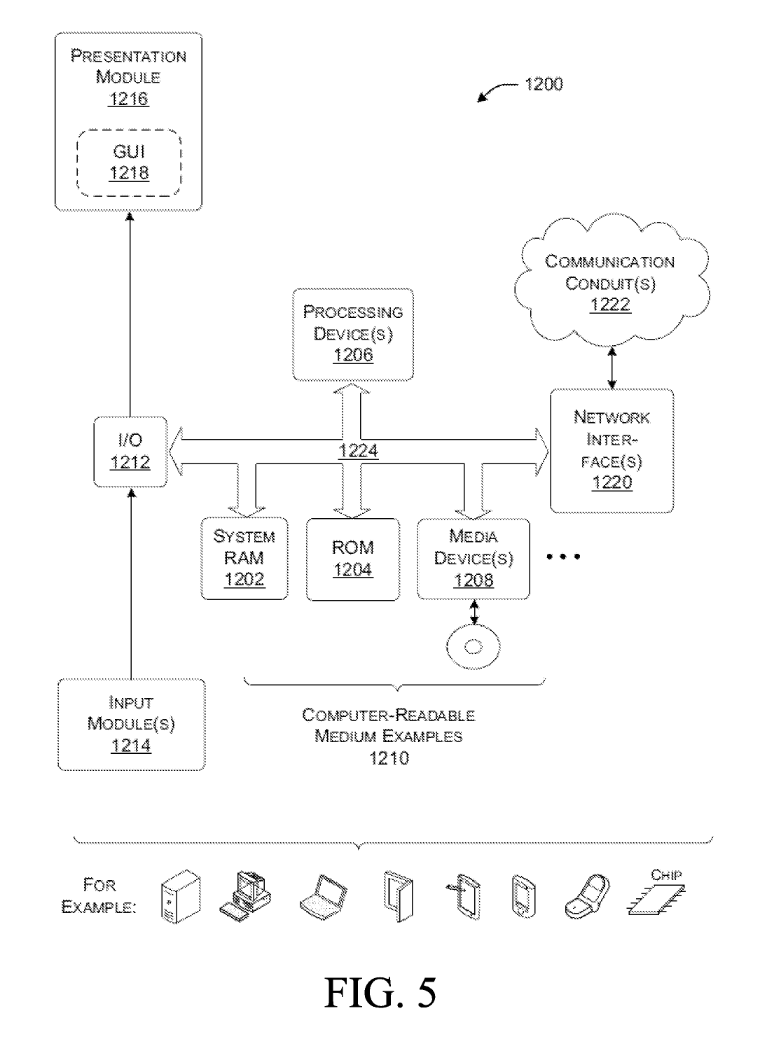

Referring to FIG. 1, an application 100 is a computer program for which the execution is managed by an operating system 102. The operating system 102 is part of the platform for which the computer program is designed, where the platform includes computing hardware such as the computing functionality described below in connection with FIG. 5. Operating system 102 provides a display manager 104, through which generates and displays, on a display 108, a graphical interface in a display area 106 for each application. The application 100 provides data 120 to the display manager which in turn generates the graphical interface in the display area for the application.

Operating system 102 also provides an input queue 110 from which the application 100 receives inputs 112. The input queue 110 includes messages from other applications as well as processed user inputs 114 from user input devices (not shown) received by an input processing module 116. In response to processing inputs 112, the application 100 can provide completion messages 118 to the input processing module, or completion can be inferred from the application having completed an operation.

In general, a user typically has several applications operational on a computer at one time. Thus, in FIG. 1, there typically are two or more applications 100, each of which has its own input queue 110. The display manager 104 manages a display area for each application, and maintains information about the order in which the display areas are layered in the display (called a “Z”-order).

In some circumstances, an application can take a noticeable amount of time to receive and process an input 112 from its message queue, and in turn have an updated graphical interface displayed in its display area. For example, the application may have been suspended due to inactivity, with its various data swapped out of main memory into other storage, such as a disk drive. When a user reactivates the application, time is required to swap the data back into main memory from the other storage, after which the application can request the display manager to display the graphical interface for the application in the application's display area. As another example, a user can instruct the system to reposition, rotate or resize the display area for the application. Such operations on the display area can cause the application to update its graphical interface and display the updated interface in the applications' display area.

A variety of other operations can cause the display area for an application to come onto the display or to be removed from the display. Examples include minimizing the display area, starting an application, closing an application, and the like. Such operations also can take a noticeable amount of time to process data before the display can be updated.

To address the problem of slow application response to inputs, the input processing module 116, in response to certain inputs (whether system messages or user input), obtains a snapshot 130 of the application graphical interface, and other application data, through a request 132 to the display manager. A snapshot 134 is displayed initially in the application's display area in place of the actual graphical interface generated by the application 100 and the display manager 104. The input processing module provides an appropriate input to the application, to cause the application to generate an updated graphical interface to be displayed. The snapshot is displayed until the application 100 is ready to display its updated its graphical interface, at which time the input processing module returns control of the display area for the application to the display manager. The application can be deemed to be ready under a number of conditions. For example, the application can complete processing of its input. Or, the final position of its display area can be determined. Or, the application can be swapped in to memory. Other conditions can be used to trigger removal of the snapshot. Some combination of these conditions, or yet other conditions, can be used.

Additional inputs for the application that are received while the snapshot is being displayed are managed. For example, the inputs can be dropped, or coalesced, by the input processing module, depending on the type of input. For example, view states and resize inputs can be coalesced.

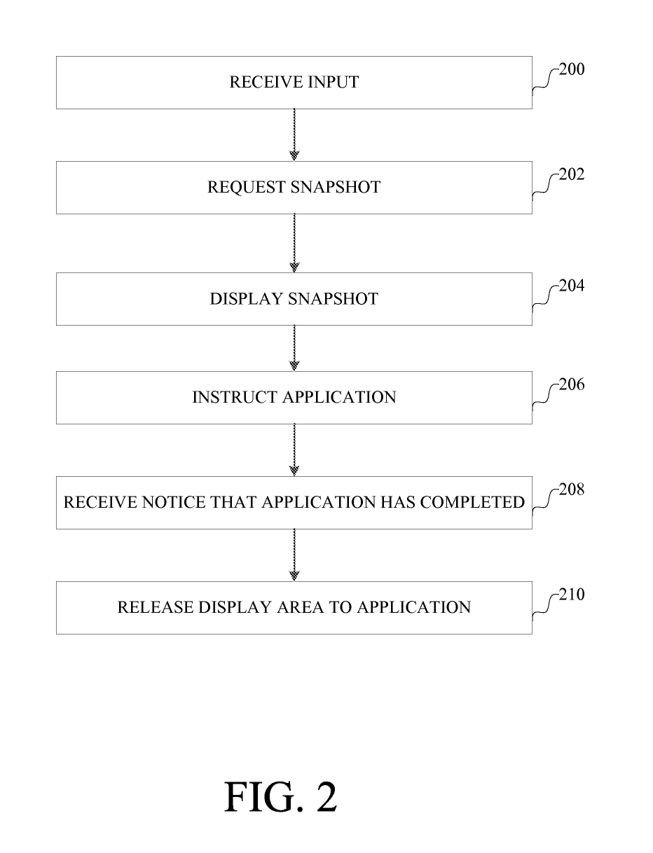

Given this context, an example implementation of such a system will be described in more detail in connection with FIGS. 2-4.

Referring to FIG. 2, a flowchart of the general operation of the input processing module will now be described.

After an input is received 200 that causes the display area of an application to be modified, the input processing module requests 202 a snapshot of the graphical interface for the application from the display manager. The snapshot is then displayed 204 in the display area for the application. The application is then instructed 206 to process an input, corresponding to the input received by the input processing module. When the application completes processing and its graphical interface is updated and ready for display, the input processing module receives 208 notice of this completion, and the display area is released 210 to the application. While the snapshot is displayed, other inputs for the application can be discarded.

Some of these steps in FIG. 2 will now be described in more detail.

To create a snapshot and provide a reasonably smooth transition between the snapshot and the actual graphical interface of the application, some additional information about the application can be helpful. For example, if the display area for the application is presented as a window with labeling and controls, and if the snapshot obtained from the display manager is an image of the contents of the window, then additional information for generating the window, labeling and controls is obtained. For example, the input processing module can obtain the name of the application and its z-order. Thus, the information obtained to generate the displayed snapshot is such that the displayed snapshot (at 204) and the interface of the application are the same.

Snapshots also are data structures maintained by the input processing module. Several, e.g., three or four, of such data structures can be allocated at run time in the operating system, and then used for the applications as needed during run time. When an application needs a snapshot, one of the allocated data structures is assigned to the application and initialized. If more snapshots are needed during run time, more can be allocated. The data structures can be reused by other applications after a snapshot for an application is no longer used. Also, the data structure can be shared between different parts of the system that are using a snapshot-like representation of the application. For example, an animation engine can show the snapshot animating onto the screen, and can use the same snapshot that later appears on the screen that the display manager uses.

It is possible that an image to be displayed as the snapshot (at 204) is different in size from the modified display area. In such a case, the snapshot can be positioned at an appropriate place in the display area, depending on the circumstances. As just one example, an image can be displayed in one of the corners of the display area (such as the upper left corner). The snapshot can be cropped at the other edges (bottom and right) of the display area. Or, if the snapshot does not extend to the bottom and right edges of the display area, a background color can be used to fill the remaining space in the display area. The background color can be a system-wide setting, or can be obtained from the application, or can be obtained from another source.

An additional benefit of using snapshots in this manner is that the application receives one instruction (at 206) for an operation to be performed, while other inputs to the application are discarded. Thus, the application is provided a stable environment in which to update its graphical interface. As described in more detail below, the instruction (at 206) can depend on the kind of input that is being processed. For example, if the input is a resize, rotation or reposition of the display area for an application, then it is desirable to have the application update its graphical interface once. Thus, upon receiving the first input to resize, rotate or reposition a window, the input processing module generates a snapshot. However, the input processing module can wait to verify that no additional inputs are received that change the parameters of the resize, rotation or repositioning operation. After waiting, the input processing module can instruct the application.

There are also many ways in which the input processing module can be notified (at 208) that the application is ready, depending on the operating system. In some cases, the application indicates to the operating system that an input has been processed. In this case, the input processing module and display manager can then initiate a transition (at 210), such as a cross-fade, from the snapshot to the graphical interface for the application.

Having now described the general operation of such a system, some specific examples of inputs that modify the display area will now be described.

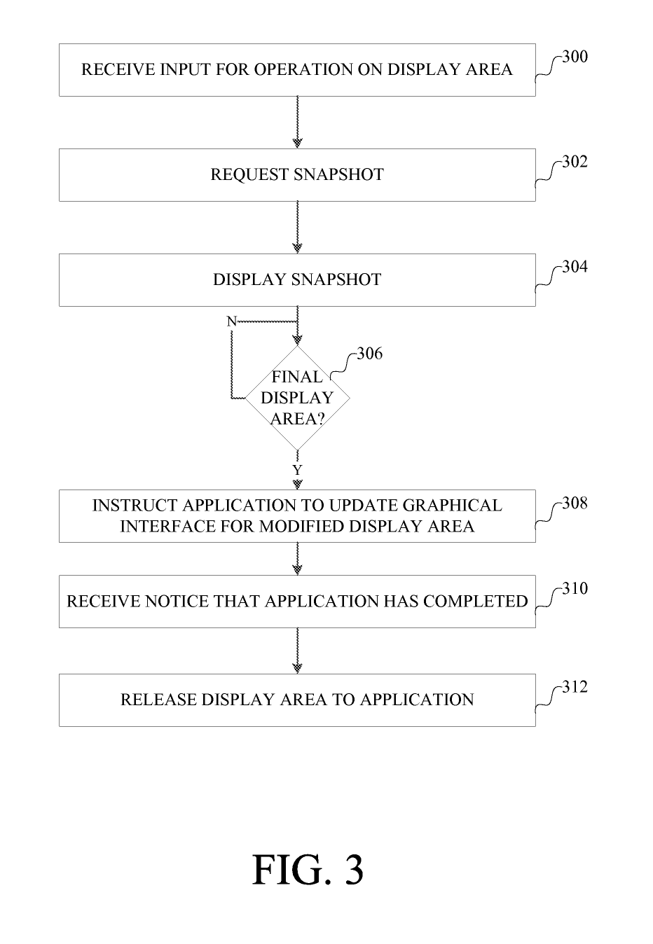

FIG. 3 is a flowchart describing an example implementation of how operations that modify the display area, such as resizing, repositioning and rotating, can be processed.

The input processing module receives 300 an input for an operation on a display area, such as a reposition, resizing or rotation. The input processing module requests 302 a snapshot for the application, and then displays 304 the snapshot in the application's display area. The input processing module waits until, and determines 306 whether, some triggering event has occurred indicated the application is ready, such as whether the final position, size or orientation of the display area has been reached, or whether the application has painted it graphical interface, or whether the application has been read into main memory. When such a determination has been made, the application is instructed 308 to update the graphical interface for the modified display area. When a notice is received 310 that the application has completed such an update, the display area is released 312 to the application.

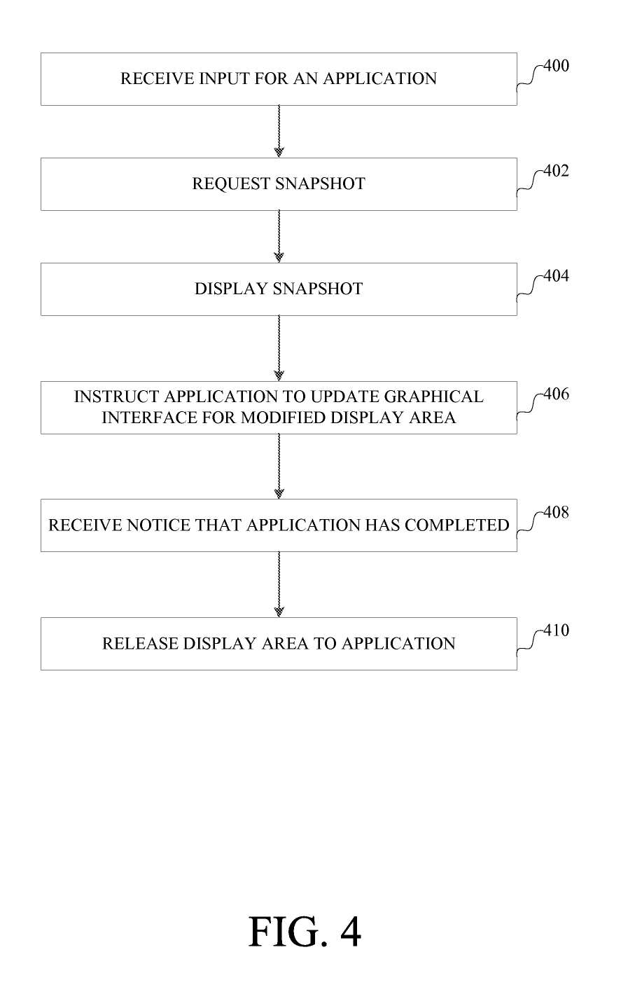

FIG. 4 is a flowchart describing an example implementation of how operations that bring a display area into view or remove it from view can be processed.

The input processing module receives 400 an input for an application that causes its display area to come onto a display or be removed from the display. For example, a user can switch away from an application or back to an application, causing its display area to be removed or presented; a suspended application can be reactivated; an application can be placed in the background for processing. The input processing module requests 402 a snapshot for the application, and then displays 404 the snapshot in the application's display area. The application is instructed 406 to update its graphical interface and otherwise proceed with the operation that triggered the snapshot to be created. When a notice is received 408 that the application has completed such an update, the display area is released 410 to the application.

In the case where an application is being suspended or removed from the screen, the display of the snapshot is likely brief, and the resulting display area for the application is typically minimized.

In the case where an application is coming back on the screen, perhaps from being suspended (i.e., with no processor cycles being provided to it) or running in the background, the snapshot can be displayed until the application is ready to process inputs from the user. In some cases, the application may be hung or nonresponsive. The input processing module can set a timer for an amount of time that can pass for a notice to be received that the application is ready. If such a notice is not received in time, the application can be terminated.

Such an input processing module provides for displaying snapshots while an application is updating its graphical interface. Any operations by the application that are responsive to inputs through the application's input queue could be processed in this manner by the input processing module. For each kind of input for which use of a snapshot is desired, the input processing module can be implemented to process the input, create a snapshot, instruct the application and then allow the application to display its updated graphical interface when ready. Thus, the end user has a better experience with the application. Additionally, because the operating system remains responsive, the user's positive impression of the system performance is maintained.

FIG. 5 sets forth illustrative computing functionality 1200 that can be used to implement any aspect of the functions described above. For example, the computing functionality 1200 can be used to implement any aspect of the system of FIG. 1. Such modules in FIG. 1 can be implemented on one or more computing functionalities, and in some cases a distributed system can have each module reside on its own computing functionality. In the deployment of an application program or library, an application framework, library and program using the library can utilize one or more computing functionalities as well. In all cases, the computing functionality 1200 represents one or more physical and tangible processing mechanisms.

The computing functionality 1200 can include volatile and non-volatile memory, such as RAM 1202 and ROM 1204, as well as one or more processing devices 1206 (e.g., one or more central processing units (CPUs), and/or one or more graphical processing units (GPUs), and/or other coprocessors, etc.). The computing functionality 1200 also optionally includes various media devices 1208, such as a hard disk module, an optical disk module, and so forth. The computing functionality 1200 can perform various operations, and manage data in memory, as identified above when the processing device(s) 1206 processes (e.g., executes or interprets) instructions that are maintained by memory (e.g., random access memory (RAM) 1202, whether static or dynamic, read-only memory (ROM) 1204, whether erasable or not, or elsewhere).

More generally, instructions and other information can be stored on any computer readable medium 1210, including, but not limited to, static memory storage devices, magnetic storage devices, optical storage devices, and so on. The term computer readable medium also encompasses plural storage devices. In all cases, the computer readable medium 1210 represents some form of physical and tangible entity.

The computing functionality 1200 also includes an input/output module 1212 for receiving various inputs (via input modules 1214), and for providing various outputs (via output modules). Input module 1214 may utilize various input device(s) such as a keyboard, mouse, pen, camera, touch input device, and so on. Other input devices that support natural user interfaces also can be used. A natural user interface is any interface technology that enables a user to interact with a device in a “natural” manner, free from artificial constraints imposed by other mechanical input devices. Examples of natural user interfaces include, but are not limited to, speech recognition, touch and stylus recognition, gesture recognition both on screen and adjacent to the screen, air gestures, head and eye tracking, voice and speech, vision, touch, gestures, and machine intelligence. Various input devices, such as sensors, are used to support such natural user interfaces. Output modules may utilize various output device(s) such as a display, speakers, a printer, and so on. One particular output mechanism may include a presentation module 1216 and an associated graphical user interface (GUI) 1218.

The computing functionality 1200 can also include one or more network interfaces 1220 for exchanging data with other devices via one or more communication conduits 1222. One or more communication buses 1224 communicatively couple the above-described components together.

The communication conduit(s) 1222 can be implemented in any manner, e.g., by a local area network, a wide area network (e.g., the Internet), etc., or any combination thereof. The communication conduit(s) 1222 can include any combination of hardwired links, wireless links, routers, gateway functionality, name servers, etc., governed by any protocol or combination of protocols.

The computing functionality can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving an input for an application that instructs an application to update its graphical interface;
generating a snapshot of the graphical interface of the application into memory;
initially displaying the snapshot in a display area for the application until the updated graphical interface is ready from the application; and
displaying the updated graphical interface for the application in the display area for the application when the application is ready.

2. The computer-implemented process of claim 1, wherein the snapshot is a data structure including an image of the graphical interface of the application.

3. The computer-implemented process of claim 1, further comprising allocating snapshots in memory for use by applications at run time.

4. The computer-implemented process of claim 1, further comprising instructing the application to update its graphical user interface.

5. The computer-implemented process of claim 4, further comprising managing further inputs to the application until the updated graphical interface is ready from the application.

6. The computer-implemented process of claim 1 wherein the input includes one of rotation, resizing and rotation of a display area of an application.

7. An article of manufacture comprising:
a computer storage medium;
computer program instructions stored on the computer storage medium which, when processed by a processing device, instruct the processing device to perform a process comprising:
receiving an input for an application that instructs an application to update its graphical interface;
generating a snapshot of the graphical interface of the application into memory;
initially displaying the snapshot in a display area for the application until the updated graphical interface is ready from the application; and
displaying the updated graphical interface for the application in the display area for the application when the application is ready.

8. The article of manufacture of claim 7, wherein the snapshot is a data structure including an image of the graphical interface of the application.

9. The article of manufacture of claim 7, further comprising allocating snapshots in memory for use by applications at run time.

10. The article of manufacture of claim 7, further comprising instructing the application to update its graphical user interface.

11. The article of manufacture of claim 10, further comprising managing further inputs to the application until the updated graphical interface is ready from the application.

12. The article of manufacture of claim 7, wherein the input includes one of rotation, resizing and rotation of a display area of an application.

13. A computing machine comprising:
a processor that executes an operating system and applications managed by the operating system, wherein applications provide a graphical interface for a display area to be displayed on a display;
wherein the operating system includes an input processing module configured to
receive an input for an application that instructs an application to update its graphical interface;
generate a snapshot of the graphical interface of the application into memory; and
initially display the snapshot in a display area for the application until the updated graphical interface is ready from the application; and
wherein the application displays the updated graphical interface for the application in the display area for the application when the application is ready.

14. The computing machine of claim 13, wherein the snapshot is a data structure including an image of the graphical interface of the application.

15. The computing machine of claim 13, further comprising allocating snapshots in memory for use by applications at run time.

16. The computing machine of claim 13, further comprising instructing the application to update its graphical user interface.

17. The computing machine of claim 16, further comprising managing further inputs to the application until the updated graphical interface is ready from the application.

18. The computing machine of claim 13, wherein the input includes one of rotation, resizing and rotation of a display area of an application.

19. The computing machine of claim 13, wherein the input includes an operating that brings the display area of an application onto a display.

20. The computing machine of claim 13, wherein the input includes an operating that removes the display area of an application from a display.
